(19) United States
(12) Patent Application Publication
(10) Pub. No.: US 2006/0213172 A1
(43) Pub. Date: Sep. 28, 2006

(54) Tine of a conditioner roller

(76) Inventors: David Beaufort, Beaujeu (FR); Heinrich Tepe, Gray La Ville (FR); Jerome Repellin, Gray (FR)

Correspondence Address: DEERE & COMPANY, ONE JOHN DEERE PLACE, MOLINE, IL, 61265, US

(21) Appl. No.: 11/388,378

(22) Filed: Mar. 24, 2006

(30) Foreign Application Priority Data
Mar. 26, 2005 (DE) 10 2005 013 964.7

(51) Int. Cl. A01D 80/00

(52) U.S. Cl. 56/400

(57) ABSTRACT

The present invention provides a tine having segments that extend in a converging manner. As a result of this configuration, the harvested crop can be thrown off the tine more easily and into the desired windrow. A base is formed as a consequence of this configuration. The base closes or reduces open space between adjoining tines and increases the conveying surface.

### BACKGROUND

1. Field of the Invention

The present invention relates to a tine of a conditioner rotor, such as a conditioner rotor used to speed up the process of drying a harvested crop.

2. Description of Related Art

Existing tines of a conditioner rotor are often configured as Y-tines or flails or as I-tines (see U.S. Pat. No. 4,592,194) in order to speed up the drying process of the harvested crop (also see DE 201 15 919 or U.S. Published Application No. 2005/0126148 A1).

A problem with this type of design is that the harvested crops are not always moved by the conditioner rotor and, instead, are dropped beneath it on the ground instead of being placed in a windrow. Additionally, the crops may also become trapped within the tines themselves.

In view of the above, it is apparent that there exists a need for an improved tine for the conditioner rotor that addresses the above mentioned disadvantages.

### SUMMARY

In satisfying the above need, as well as overcoming the drawbacks and other limitations of the related art, the present invention provides an improved tine having reduced friction acting on the harvested crops. This improves the throwing properties of the tine and allows the crops to reach the desired windrow. This effect is was previously achieved by having a significant area of the tine, although not necessarily the entire tine, being tapered towards the end of the tine.

With the present invention, the tines can be made of plastic or metal. Typically, a plurality of tines is disposed on the conditioner rotor, for example 50 or more. One tine may also comprise more than two segments, (e.g., 4, 6, 8 or more segments) that are combined in pairs. Alternatively, rather than tines comprising several segments, it is also possible to provide tines with a single inclined segment, the tines themselves being mounted individually on the conditioner rotor and arranged relative to an adjacent tine such that converging segments are created.

A simple means for mounting the tine, and at the same time increasing its conveying surface, results by providing a radially extending center segment between the two converging segments. The radially extending center segment is connected on one end to the conditioner rotor, for example in a pivoting manner. On its other end, the center segment extends into the space between the two converging segments. Alternatively, each converging segment may be configured such that it is connected individually to the conditioner rotor.

The radially extending segment ends at a location between the converging segments, thus preventing crop picked up between the segments from becoming trapped in a wedge-shaped gap and unable to exit the tines. How far the radially extending center segment should end in front of the inclined segment depends on the properties of the crops being harvested.

Providing flexible tines is advantageous since they give way when they come into contact with a foreign object or are otherwise overloaded. Additionally, due to vibrations, crops that become trapped within the tines will dislodge more easily. On the other hand, rigid tines offer the advantage of not giving way even when harvesting a high quantity of crops. In this manner, they aid in avoiding imbalances. Moreover, the mass production costs for stamping, forging, casting or extruding rigid tines are lower than those for fabricating flexible tines made of spring steel. In the end, the application conditions will determine whether rigid or flexible tines are the better choice. In either case, the tines can be made of steel or plastic as appropriate.

In order to prevent harvested crop from becoming trapped under certain harvesting conditions in the converging space between two segments, the inventors have found it to be helpful if the segments do not converge in their free end regions, but instead extend parallel to each other. Alternatively, it is also feasible to use curved segments (instead of straight segments) that transition from a converging course to a substantially parallel course. A straight design of the segments, however, is better in configurations where the incline is relatively small.

The conveying surface of the tines is increased when a base, which may connect the segment to the conditioner rotor, is provided in a manner that extends parallel or substantially parallel to the circumferential surface of the conditioner rotor. Such a base may connect several segments together at the same time. Contrary to the prior art, the space between the radially inward ends of the tines is filled in by the base, so that harvested crop located therein is picked up and does not drop to the ground outside the windrow.

The incline of the segment also depends on the properties of the harvested crop; while any incline to a radial line within a range of 1 to 45 degrees is permitted, an incline of 5 to 15 degrees to the radial line has been determined to be most successful in most cases.

If individual tines are provided on a conditioner rotor, the above-described effects result when the tines are arranged in pairs relative to each other on the rotor such that the segments of the pairs converge.

Further objects, features and advantages of this invention will become readily apparent to persons skilled in the art after a review of the following description, with reference to the drawings and claims that are appended to and form a part of this specification.

### BRIEF DESCRIPTION OF THE DRAWINGS

The drawings illustrate one example of the present invention, which will be explained in more detail hereinafter, wherein:

FIG. 1 is a crop conditioner in a side view comprising a conditioner rotor and tines according to the present invention;

FIG. 2 is a front view of the conditioner rotor of FIG. 1; and

FIG. 3 is a front, perspective view of a tine embodying the principles of the present invention.

### DETAILED DESCRIPTION

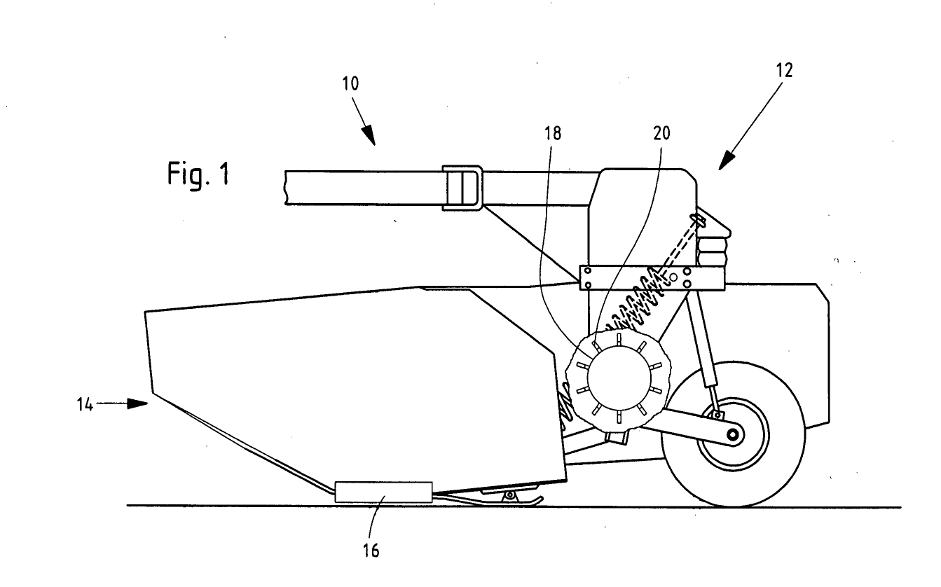

Referring now to the drawings, a tine of a crop conditioner embodying the principles of the present invention is generally illustrated therein and designated at 10. According to FIG. 1, the crop conditioner 10 comprises a chassis 12 for the purpose of supporting the crop conditioner 10 and mounting it to a tractor unit (not shown). On the chassis 12 is a housing 14 that accommodates a cutter bar 16 and a conditioner rotor 18.

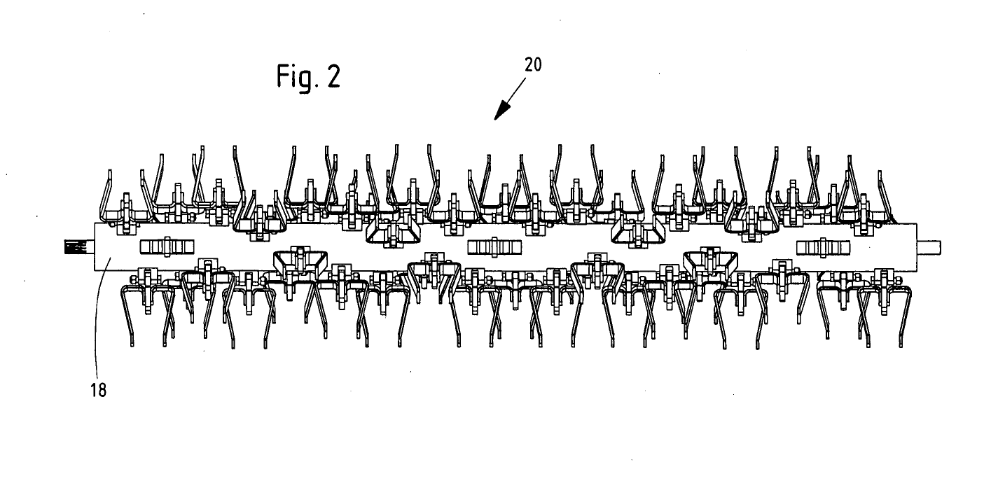

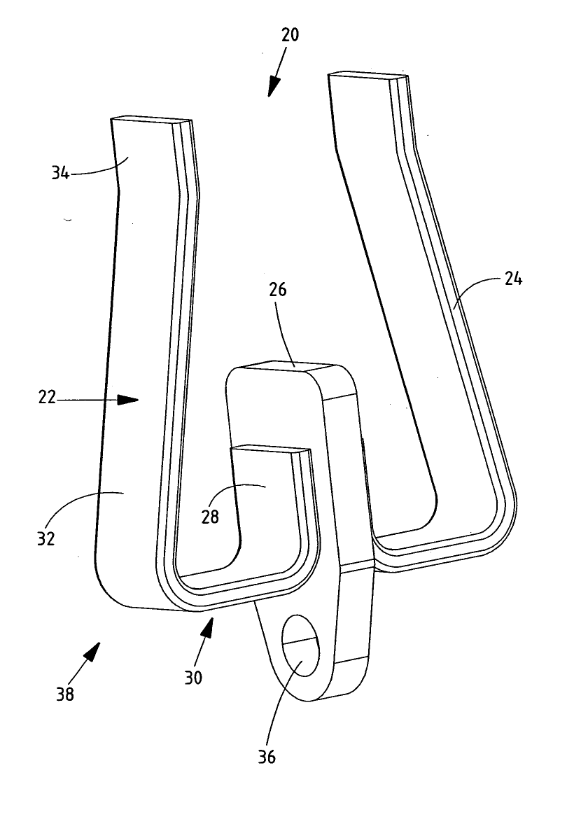

During operation of the crop conditioner 10, harvested crop (not shown) is separated from the ground by means of the cutter bar 16, is picked up by the conditioner rotor 18 and is thrown off and out of the housing 14 such that it is shaped into a windrow. To accomplish this, the conditioner rotor 18 is provided with tines 20, which may be arranged as illustrated in FIG. 2. Axially, the tines 20 extend along a helical path having more or less evenly spaced rows on the circumferential surface of the conditioner rotor 18 (see FIG. 2). Other than of the shape of the tines 20 themselves, this arrangement is conventional and corresponds to the design of the prior art.

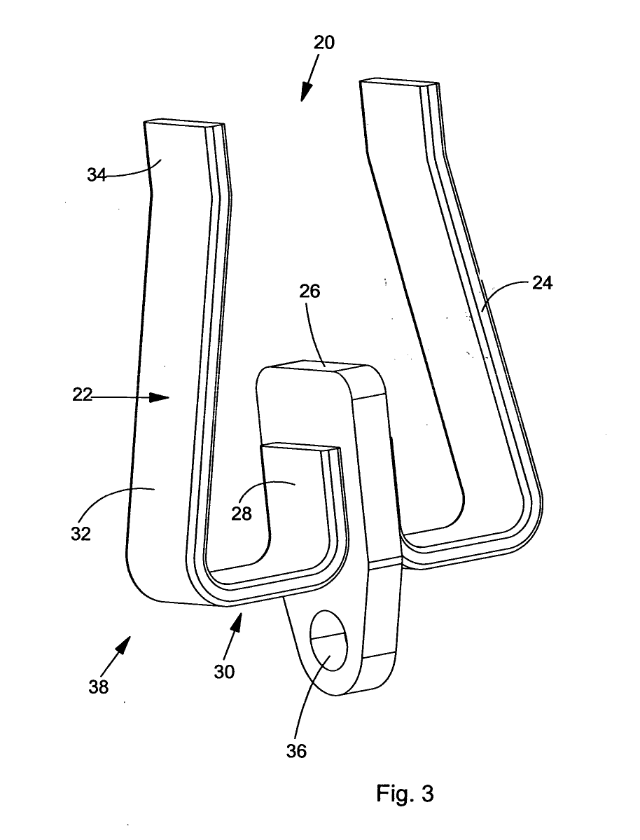

FIG. 3 illustrates a tine 20 embodying the principles the present invention. The tine 20 basically has the shape of a fork and includes a left segment 22, a right segment 24 and a center segment 26. The tine 20, as shown in the example, is pivotally mounted to the conditioner rotor 18, although it may alternatively be rigidly mounded.

The left segment 22 and right segment 24 are preferably designed with the same geometry, and are fastened, e.g., welded, bolted, riveted or otherwise fixed, to the center segment 26 in a laterally inverted manner. Each segment 22 and 24 is thus generally configured in the shape of a J or L. While the following description relates to the left segment 22, it similarly applies to the right segment 24, which is a mirror image of the left segment 22.

The left segment 22 includes a mounting section 28, a base section 30, an inclined section 32 and an end section 34. The mounting section 28 extends generally radially and serves to connect the left segment 22 to the center segment 26. The base section 30 extends perpendicularly to the mounting section 28, generally parallel to the circumferential surface of the conditioner rotor 18, and away from the center segment 26. In the embodiment shown, the inclined section 32 extends from the base section 30 at an angle of, for example, 10 degrees to a radial line from the conditioner rotor 18 or center segment 26, which runs perpendicular to the base section 30 and generally parallel to the mounting section 28. The angle may be any angle within a range of 1 to 45 degrees, although an angle of 5 to 15 degrees is preferred and has been found to be optimal for most applications.

The end section 34 initially follows the inclined section 32, extending radially outward and substantially parallel to the mounting section 28. The end section 34 thus forms a radially outward end region of the left segment 22.

At a radially inward end region of the center segment 26, near the base section 30, the center segment 26 includes a bore 36 configured to accommodate a pin (not shown) for mounting the tine 20 to the conditioner rotor 18 or an appropriately configured bracket mounted thereon. The center segment 26 is fastened, for example by welding, rivets, screws, or the like, to the respective mounting section 28 of the left and right segments 22 and 24. On its radially outward end region, the center segment 26 extends beyond the mounting sections 28 and ends approximately at about half the length of the left and right segments 22 and 24.

In an alternative embodiment, the left, right and center segments 22, 24 and 26 are configured as a single, unitary piece, instead of the three piece construction mentioned above.

As seen in FIG. 3, the tine 20 has a tulip-shaped design (i.e. the inclined sections 32 converge as they progress from radially inward to radially outward, with the end sections 34 extending generally parallel to each other). The base sections 30, together with the center segment 26, combine to form a base 38. The base 38 extends generally along the circumferential surface of the conditioner rotor 18 such that it nearly reaches to the base 38 of the next tine 20 on the conditioner rotor 18.

As a person skilled in the art will readily appreciate, the above description is meant as an illustration implementing the principles this invention. This description is not intended to limit the scope or application of this invention in that the invention is susceptible to modification, variation and change, without departing from spirit of this invention, as defined in the following claims.

What is claimed is:

1. A tine of a conditioner rotor for moving a harvested crop comprising:
at least two segments generally oriented in a radially outward direction from the rotor, the segments including converging portions that converge toward their radially outward ends, wherein the converging portions are formed by an inclined section extending at an angle to a radial line from the conditioner rotor.

2. A time according to claim 1, wherein the tine is pivotally mounted on the on the conditioner rotor.

3. A tine according to claim 1, wherein a radially extending center segment is disposed between the segments and connected to the segments to one another.

4. A tine according to claim 3, wherein the radially extending center segment pivotally mounts the tine on the conditioner rotor.

5. A tine according to claim 3, wherein the radially extending center segment ends radially between the converging portions.

6. A tine according to claim 1, wherein the tine is made of a flexible material.

7. A tine according to claim 1, wherein the tine is made of a rigid material.

8. A tine according to claim 1, wherein the inclined section is straight.

9. A tine according to claim 1, wherein the tine includes a base, which extends substantially parallel to the circumferential surface of the conditioner rotor.

10. A tine according to claim 1, wherein angle of the inclined section converges to a radial line at an angle within the range of 1 to 45 degrees.

11. A tine according to claim 10, wherein the angle of the inclined section to the radial line is in the range of about 5 to 15 degrees.

12. A tine according to claim 1, wherein the segments are arranged in pairs and the ends of the segments generally converge toward one another.

13. A tine according to claim 1, wherein the tine is made of spring steel.

14. A tine according to claim 1, wherein the tine is made of a plastic material.
